(19) United States
(12) Patent Application Publication
(10) Pub. No.: US 2015/0186548 A1
(43) Pub. Date: Jul. 2, 2015

(54) SYSTEM AND METHOD FOR ACQUIRING DATA OF ELECTRONIC CONTROL UNIT

(71) Applicant: Kia Motors Corporation, Seoul (KR)

(72) Inventors: Sung Sam Chun, Seoul (KR); Seung-Chang Park, Seoul (KR)

(21) Appl. No.: 14/467,729

(22) Filed: Aug. 25, 2014

(30) Foreign Application Priority Data
Dec. 27, 2013 (KR) 10-2013-0165491

(51) Int. Cl. G06F 17/30; H04L 29/08; G07C 5/00

(52) U.S. Cl. CPC G06F 17/30943; G07C 5/008; H04L 67/12

(57) ABSTRACT

A system and a method of acquiring data of an electronic control unit are provided. The method includes receiving, by a telematics server, information regarding a version of the electronic control unit mounted within a vehicle from a telematics terminal and searching for a configuration file that corresponds to the version of the electronic control unit. The telematics server is configured to generate an acquirement event file for acquiring the data of the electronic control unit using the configuration file and transmit the acquirement event file to the telematics terminal. In response to transmitting the acquirement event file, the terminal server is configured to receive the telematics terminal the data of the electronic control unit. In addition, data communication between the telematics terminal and the electronic control unit uses a controller area network (CAN) calibration protocol (CCP).

### CROSS-REFERENCE TO RELATED APPLICATION

This application claims priority to and the benefit of Korean Patent Application No. 10-2013-0165491 filed in the Korean Intellectual Property Office on Dec. 27, 2013, the entire contents of which are incorporated herein by reference.

### BACKGROUND

(a) Field of the Invention

The present invention relates to a system and a method of acquiring data of an electronic control unit, and more particularly, to a system and a method of acquiring data of an electronic control unit using a controller area network (CAN) calibration protocol (CCP).

(b) Description of the Related Art

Recently, as an electronic technology becomes more integrated within vehicles, a vehicular network technology for connecting an electronic control unit (hereinafter, referred to as an “ECU”) and an electronic device has increased. Basic devices and convenient devices of a vehicle, such as an engine, an automatic transmission, an air conditioner, a brake, a steering wheel, and a lamp, are electronically controlled. When developing the ECU, various parameters, such as a vehicle speed, revolutions per minute (RPM) of the engine, and a pressure of the brake, serve as input variables of a control algorithm used in the ECU. Even though the ECU adopts the same input variable and algorithm, the ECU is used in various types of vehicle, to cause the ECU to implement driving performance based on the type of vehicle. Accordingly, a correction operation is performed until the ECU is configured to be appropriate to a particular type of vehicle by adjusting a value of a parameter, instead of correcting the input variable or the algorithm.

For example, even though the same algorithm is used for operating the brake, the value of the parameter changes based on a difference in a physical attribute (e.g., weight of the vehicle, and the like) of each type of vehicle. In addition, the ECU is developed to monitor data using a debugger. However, the debugger is substantially high in cost, and when the ECU is already mounted within the vehicle, it may be difficult to monitor the data using the debugger. Further, the monitoring of the data of the ECU in a limited space has a limitation for the amount of data which may be acquired.

The above information disclosed in this section is merely for enhancement of understanding of the background of the invention and therefore it may contain information that does not form the prior art that is already known in this country to a person of ordinary skill in the art.

### SUMMARY

The present invention provides a system and a method of acquiring desired data of an ECU using a CCP.

An exemplary embodiment of the present invention provides a method of acquiring data of an electronic control unit that may include: transmitting, by a telematics terminal, information regarding a version of the electronic control unit mounted within a vehicle to a telematics server; searching for, by the telematics server, a configuration file that corresponds to the version of the electronic control unit; generating, by the telematics server, an acquirement event file for acquiring the data of the electronic control unit using the configuration file; transmitting, by the telematics server, the acquirement event file to the telematics terminal; acquiring, by the telematics terminal, the data of the electronic control unit using the acquirement event file; and transmitting, by the telematics terminal, the data of the electronic control unit to the telematics server, in which data communication between the telematics terminal and the electronic control unit may use a controller area network (CAN) calibration protocol (CCP).

The configuration file may include data item information, data address information, and data conversion rule information. The acquirement event file may include data item information, data address information, data conversion rule information, and acquirement period information regarding data desired to be acquired. The acquirement event file may further include acquirement period information. In addition, the method may further include: requesting, by the telematics server, a version of the electronic control unit from the telematics terminal; and determining, by the telematics terminal, the version of the electronic control unit. Data communication between the telematics terminal and the telematics server may use a wireless network.

Another exemplary embodiment of the present invention provides a system for acquiring data of an electronic control unit that may include: a telematics server configured to search for a configuration file that corresponds to a version (e.g., a program version of the ECU) of the electronic control unit mounted within a vehicle, and generate an acquirement event file for acquiring data of the electronic control unit using the configuration file; and a telematics terminal configured to download the acquirement event file from the telematics server, acquire data of the electronic control unit using the acquirement event file, and transmit the data of the electronic control unit to the telematics server, in which data communication between the telematics terminal and the electronic control unit may use a controller area network (CAN) calibration protocol (CCP).

The configuration file may include data item information, data address information, and data conversion rule information. The acquirement event file may include data item information, data address information, data conversion rule information, and acquirement period information about data desired to be acquired. The acquirement event file may further include acquirement period information.

The telematics server may further be configured to request a version of the electronic control unit from the telematics terminal, and the telematics terminal may be configured to determine the version of the electronic control unit, and transmit information about the version of the electronic control unit to the telematics server. Data communication between the telematics terminal and the telematics server may use a wireless network. The telematics server may include a database server in which a configuration file that corresponds to each of a plurality of electronic control units may be stored.

As described above, according to the exemplary embodiments of the present invention, the telematics server may be configured to acquire desired data of the ECU based on an acquirement condition and an acquirement period. Further, when a remote vehicle diagnosis service is requested from the telematics server, it may be possible to specifically select data necessary for the diagnosis of the vehicle and acquire the necessary data. In addition, it may be possible to utilize acquired data during an after-sales service or development of a new vehicle.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present invention, and wherein:

FIG. 1 is an exemplary network configuration diagram illustrating a system for acquiring data of an ECU according to an exemplary embodiment of the present invention;

FIG. 2 is an exemplary block diagram illustrating a telematics terminal according to an exemplary embodiment of the present invention; and

FIG. 3 is an exemplary flowchart illustrating a method of acquiring data of the ECU according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

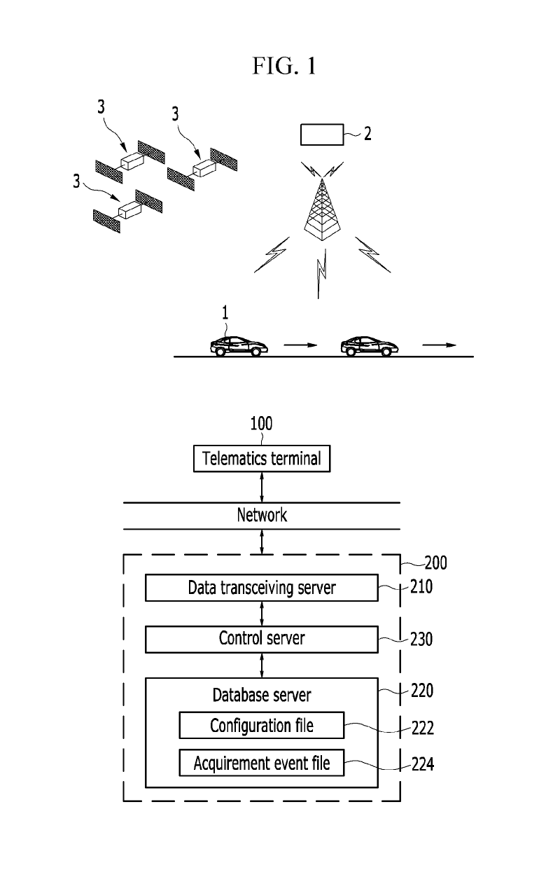

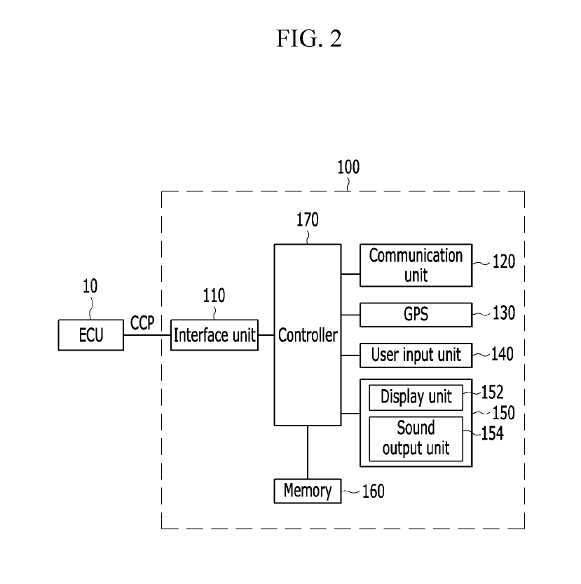

FIG. 1 is an exemplary network configuration diagram illustrating a system for acquiring data of an ECU according to an exemplary embodiment of the present invention. FIG. 2 is an exemplary block diagram illustrating a telematics terminal according to an exemplary embodiment of the present invention. As illustrated in FIGS. 1 and 2, a system for acquiring data of an ECU according to an exemplary embodiment of the present invention may include a telematics terminal 100 disposed within a vehicle 1, and a telematics server 200 disposed within a telematics center 2. The telematics terminal 100 may be executed by a terminal processor and the telematics server 200 may be executed by a server processor.

Telematics is a combined term of telecommunication and informatics, and is defined as a next generation information providing service for a vehicle through a combination of an IT industry, in which wireless communication, contents, and the like are organically connected with each other, and an auto industry. The telematics service may be configured to provide various services, such as traffic and driving information, emergency situation handling information, remote vehicle diagnosis service, the Internet, and the like by utilizing a wireless communication technology and a global positioning system (GPS) technology.

In particular, the telematics terminal 100 may be configured to receive GPS signals from three or more GPS satellites 3, and calculate a current position of the vehicle 1 based on the GPS signal and map data. The telematics terminal 100 may be configured to acquire data from an ECU 10. The ECU 10 may use a controller area network (CAN) as a protocol of a physical layer. Further, the ECU 10 may use a CAN calibration protocol (CCP) as a protocol of an application layer of the CAN.

The CCP is a protocol configured to acquire and correct (e.g., adjust) data when the ECU 10 is developed. The CCP is defined by Association for Standardization of Automation and Measuring Systems (ASAM). The CCP is based on a master/slave application which starts communication by transmitting a command to a slave node by a master. To use the CCP, a configuration file (e.g., “A2L file”, defined by the ASAM MCD 2MC/ASAP2 standard) 222 that corresponds to a version of the ECU 10 is required. Since the version of the ECU 10 may differ based on the type of vehicle, a specification of an engine, a region, and the like, the configuration file 222 also differs based on the version of the ECU 10. Further, when a bug is generated in the ECU 10 (e.g., a virus or the like in the program software of the ECU), or a new function is added to the ECU 10, when the ECU 10 is updated (reprogrammed), the configuration file 222 that corresponds to a version of the updated ECU 10 may require change. Accordingly, the corresponding configuration file 222 should be provided when the version of the ECU 10 requires a change, an update, or the like.

The configuration file 222 may include data item information, data address information, and data conversion rule information. For example, the configuration file 222 may include data item information, data address information, and data conversion rule information that corresponds to vehicle speed data detected by a speed sensor, and the data conversion rule information may be information regarding an expression for converting the vehicle speed data to a physical quantity. Accordingly, as illustrated in FIG. 2, the telematics terminal 100 may include an interface unit 110, a communication unit 120, a GPS 130, a user input unit 140, an output unit 150, a memory 160, and a controller 170. The controller 170 may be configured to execute the interface unit 110, the communication unit 120, the GPS 130, the user input unit 140, the output unit 150, and the memory 160. When the constituent elements are implemented in actual application, two or more constituent elements may be combined into one constituent element, or one constituent element may be subdivided into two or more constituent elements when necessary for configuration.

The interface unit 110 may serve as a passage of the external devices connected with the telematics terminal 100. The interface unit 110, which may be a CAN communication module, may be configured to perform data communication with the ECU 10 using the CCP. The communication unit 120 may be configured to transceive data with the telematics server 200 via a wireless network, such as the wireless Internet, a wireless phone network, a wireless LAN (WiFi) network, a 3-generation (3G) network, a 4G long term evolution (LTE) network, a Bluetooth network, a radio frequency identification (RFID) network, an infrared data association (IrDA) network, a ZigBee network, a ultra wideband (UWB) network, and a near field communication (NFC) network.

The GPS 130 may be configured to receive GPS signals from three or more artificial satellites, and calculate position information of the vehicle. The position information may include information regarding coordinates of the vehicle indicated with latitude and longitude. The user input unit 140 may be configured to generate input data to operate the telematics terminal 100 by the user. The user input unit 140 may include a touch pad, a key pad, a jog shuttle, and the like. Particularly, when the touch pad and a display unit 152, which will be described below, form a layer structure, the touch pad may be called a touch screen. Further, the user may request a vehicle diagnosis service via the user input unit 140.

The output unit 150 may be configured to generate an output related to a visual or auditory sense, and may include the display unit 152 and a sound output unit 154. The display unit 152 may be configured to display information processed by the telematics terminal 100. For example, when the telematics terminal 100 is providing the diagnosis service, the display unit 152 may be configured to display a user interface (UI) or a graphic user interface (GUI) related to the diagnosis service. The display unit 152 may include a liquid crystal display (LCD), a thin film transistor liquid crystal display (TFT LCD), an organic light emitting diode (OLED), a flexible display, a 3D display, and the like. When the display 152 and a sensor configured to detect a touch motion form a layer structure, the display unit 152 may be used as an input device, in addition to an output device.

The sound output unit 154 may be configured to output audio data received from the communication unit 120 or stored in the memory 160. The sound output unit 154 may be configured to output a sound signal related to a function (e.g., the guide of a route and the diagnosis of a vehicle) performed by the telematics terminal 100. The sound output unit 154 may include a receiver, a speaker, a buzzer, and the like. The memory 160 may be configured to store a program for an operation of the controller 170, and store input/output data (e.g., data of the ECU and an acquirement event file). The memory 160 may include at least one type of storage medium among a flash memory type, a hard disk type, a multimedia card micro type, a card-type memory (for example, an SD or XD memory), a random access memory (RAM), a read-only memory (ROM), an electrically erasable programmable read only memory (EEPROM), a programmable read only memory (PROM), a magnetic memory, a magnetic disk, and an optical disk.

The controller 170 may be configured to operate the telematics terminal 100, and be implemented with one or more microprocessors operated by a set program, and the set program may include a series of commands for performing respective steps included in a method of acquiring data of the ECU 10 according to an exemplary embodiment of the present invention, which will be described below.

As illustrated in FIG. 1, the telematics server 200 may include a data transceiving server 210, a database server 220, and a control server 230. When the constituent elements are implemented in actual application, two or more constituent elements may be combined into one constituent element, or one constituent element may be subdivided into two or more constituent elements if necessary for configuration.

The data transceiving server 210 may be configured to receive the data of the ECU 10 provided from the telematics terminal 100 via the network. Further, the data transceiving server 210 may be configured to transmit an acquirement event file 224, provided from the control server 230, to the telematics terminal 100 via the network. Configuration files may be stored in the database server 220. In other words, the database server 220 may be configured to store configuration files that correspond to each of a plurality of ECUs. The database server 220 may be a diagnostic information management system-inside (DIMS-I) server managed by a vehicle manufacturer. The control server 230 may be configured to determine a version of the ECU 10 through the data transceiving server 210, and search for a configuration file 222 that corresponds to the version of the ECU 10 among the configuration files stored in the database server 220.

In particular, the configuration file 222 may include data item information, data address information, and data conversion rule information. For example, the configuration file 222 may include data item information, data address information, and data conversion rule information that corresponds to vehicle speed data detected by the speed sensor, and the data conversion rule information may be information regarding an expression for converting the vehicle speed data to a physical quantity.

The control server 230 may be configured to generate the acquirement event file 224 for acquiring the data of the ECU 10 using the configuration file 222. The acquirement event file 224 may include data item information, data address information, data conversion rule information, and acquirement period information about data desired to acquire. Further, the acquirement event file 224 may further include acquirement condition information. The control server 230 may be configured to transmit the acquirement event file 224 to the telematics terminal 100 via the data transceiving server 210, and the telematics terminal 100 may be configured to acquire the data of the ECU 10 using the acquirement event file.

The telematics terminal 100 may be configured to acquire the data of the ECU 10 when the acquirement period is satisfied. A period, which may be determined by a person of an ordinary skill in the art considering an item of the data, may be set as the acquirement period. Further, the telematics terminal 100 may be configured to acquire the data of the ECU 10 when the acquirement condition is satisfied. A condition, which may be determined by a person of an ordinary skill in the art considering an item of the data, may be set as the acquirement condition. For example, the acquirement condition may be satisfied when a remote vehicle diagnosis service (e.g., when a warning lamp of a dashboard is operated) is required. The control server 230 may be configured to receive the data of the ECU 10 acquired from the telematics terminal 100 via the data transceiving server 210, and store the received data in the database server 220. The telematics center 2 may be configured to provide the driver with various services, such as a remote vehicle diagnosis service, using the acquired data of the ECU 10.

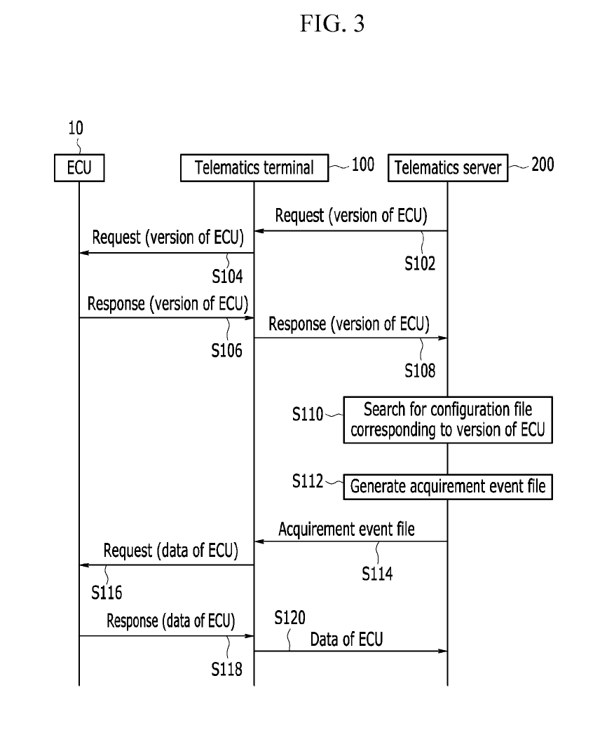

Hereinafter, a method of acquiring data of the ECU according to an exemplary embodiment of the present invention will be described in detail with reference to FIG. 3. FIG. 3 is an exemplary flowchart illustrating a method of acquiring data of the ECU according to an exemplary embodiment of the present invention. Referring to FIG. 3, the telematics server 200 may be configured to request information regarding a version of the ECU 10 from the telematics terminal 100 (S 102).

The telematics terminal 100 may be configured to receive the request of the information regarding the version of the ECU 10, and determine the version of the ECU 10. The telematics terminal 100 may be configured to request the information regarding the version of the ECU 10 from the ECU 10 (S104), and the ECU 10 may be configured to transmit the information regarding the version of the ECU 10 to the telematics terminal 100 as a response to the request (S106). The telematics terminal 100 may be configured to transmit the information regarding the version of the ECU 10 to the telematics server 200 as a response to the request of the telematics server 200 (S108).

Furthermore, FIG. 3 shows the telematics terminal 100 configured to determine the version of the ECU 10 according to the request of the telematics server 200, and even when no request from the telematics server 200 is received, the telematics terminal 100 may be configured to determine the version of the ECU 10. In other words, the telematics terminal 100 may be configured to transmit the information regarding the version of the ECU 10 to the telematics server 200 when the version of the ECU 10 is determined. The telematics server 200 may be configured to search for a configuration file that corresponds to the version of the ECU 10 (S110). The telematics server 200 may be configured to generate an acquirement event file for acquiring the data of the ECU 10 using the configuration file (S112).

The telematics server 200 may be configured to transmit the acquirement event file to the telematics terminal 100 (S114). The telematics terminal 100 may be configured to download the acquirement event file from the telematics server 200. The telematics terminal 100 may be configured to acquire the data of the ECU 10 using the acquirement event file. The telematics terminal 100 may be configured to request the data from the ECU 10 through the CCP (S116), and the ECU 10 may be configured to transmit the data to the telematics terminal 100 as a response to the request (S118). The telematics terminal 100 may be configured to transmit the data of the ECU 10 to the telematics server 200 (S120).

As described above, according to the exemplary embodiments of the present invention, the telematics server 200 may be configured to acquire desired data of the ECU 10 according to an acquirement condition and an acquirement period. Further, when the telematics server 200 is requested to provide a remote vehicle diagnosis service, it may be possible to select the data necessary for the diagnosis of the vehicle and acquire the necessary data.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

### Description of Symbols

1: Vehicle
2: Telematics center
3: Artificial satellite
10: ECU
100: Telematics terminal
200: Telematics server

What is claimed is:

1. A method of acquiring data of an electronic control unit, comprising:
receiving, by a telematics server, information regarding a version of the electronic control unit mounted within a vehicle from a telematics terminal;
searching for, by the telematics server, a configuration file that corresponds to the version of the electronic control unit;
generating, by the telematics server, an acquirement event file for acquiring the data of the electronic control unit using the configuration file;
transmitting, by the telematics server, the acquirement event file to the telematics terminal; and
receiving, by the telematics server, the data of the electronic control unit from the telematics terminal in response to transmitting the acquirement event file,
wherein data communication between the telematics terminal and the electronic control unit uses a controller area network (CAN) calibration protocol (CCP).

2. The method of claim 1, wherein the configuration file includes data item information, data address information, and data conversion rule information.

3. The method of claim 1, wherein the acquirement event file includes data item information, data address information, data conversion rule information, and acquirement period information about data desired to acquire.

4. The method of claim 3, wherein the acquirement event file further includes acquirement period information.

5. The method of claim 1, further comprising:
requesting, by the telematics server, a version of the electronic control unit from the telematics terminal.

6. The method of claim 1, wherein data communication between the telematics terminal and the telematics server uses a wireless network.

7. A system for acquiring data of an electronic control unit, comprising:
a telematics server configured to search for a configuration file that corresponds to a version of the electronic control unit mounted within a vehicle, and generate an acquirement event file for acquiring data of the electronic control unit using the configuration file; and
a telematics terminal configured to download the acquirement event file from the telematics server, acquire data of the electronic control unit using the acquirement event file, and transmit the data of the electronic control unit to the telematics server,
wherein data communication between the telematics terminal and the electronic control unit uses a controller area network (CAN) calibration protocol (CCP).

8. The system of claim 7, wherein the configuration file includes data item information, data address information, and data conversion rule information.

9. The system of claim 7, wherein the acquirement event file includes data item information, data address information, data conversion rule information, and acquirement period information about data desired to acquire.

10. The system of claim 9, wherein the acquirement event file further includes acquirement period information.

11. The system of claim 7, wherein:
the telematics server is configured to request a version of the electronic control unit from the telematics terminal, and
the telematics terminal is configured to determine the version of the electronic control unit, and transmit information regarding the version of the electronic control unit to the telematics server.

12. The system of claim 7, wherein data communication between the telematics terminal and the telematics server uses a wireless network.

13. The system of claim 7, wherein the telematics server includes a database server in which a configuration file that corresponds to each of a plurality of electronic control units is stored.

14. A non-transitory computer readable medium containing program instructions executed by a processor, the computer readable medium comprising:
program instructions that receive information regarding a version of the electronic control unit mounted within a vehicle from a telematics terminal;
program instructions that search for a configuration file that corresponds to the version of the electronic control unit;
program instructions that generate an acquirement event file for acquiring the data of the electronic control unit using the configuration file;
program instructions that transmit the acquirement event file to the telematics terminal; and
program instructions that receive the data of the electronic control unit from the telematics terminal in response to transmitting the acquirement event file,
wherein data communication between the telematics terminal and the electronic control unit uses a controller area network (CAN) calibration protocol (CCP).

15. The non-transitory computer readable medium of claim 14, wherein the configuration file includes data item information, data address information, and data conversion rule information.

16. The non-transitory computer readable medium of claim 14, wherein the acquirement event file includes data item information, data address information, data conversion rule information, and acquirement period information about data desired to acquire.

17. The non-transitory computer readable medium of claim 16, wherein the acquirement event file further includes acquirement period information.

18. The non-transitory computer readable medium of claim 14, further comprising:
program instructions that request a version of the electronic control unit from the telematics terminal.

19. The non-transitory computer readable medium of claim 14, wherein data communication between the telematics terminal and the telematics server uses a wireless network.
